(19) United States
(12) Patent Application Publication
(10) Pub. No.: US 2015/0260023 A1
(43) Pub. Date: Sep. 17, 2015

(54) SYSTEM AND METHOD FOR THERMALLY TREATING A SUBSURFACE FORMATION BY A HEATED MOLTEN SALT MIXTURE

(71) Applicant: GENIE IP B.V., Amsterdam (NL)

(72) Inventors: Scott Nguyen, Austin, TX (US); Harold Vinegar, Bellaire, TX (US)

(21) Appl. No.: 14/435,702

(22) PCT Filed: Oct. 16, 2013
(86) PCT No.: PCT/US13/65332

§ 371 Date: Apr. 14, 2015

Related U.S. Application Data
(60) Provisional application No. 61/714,251, filed on Oct. 16, 2012.

(51) Int. Cl. E21B 43/24; C09K 8/60; C10C 3/00; C10G 1/04; C10G 1/00

(52) U.S. Cl. CPC E21B 43/24; C10G 1/04; C10G 1/008; C10C 3/002; C09K 8/60

(57) ABSTRACT

Embodiments of the present invention relate to a method and system for pyrolyzing kerogen or mobilizing bitumen using thermal energy of a carbonate molten salt mixture having a melting point of at most 395 degrees Celsius or at most 390 degrees Celsius or at most 385 degrees Celsius. The carbonate molten salt may include lithium cations (e.g. at a cationic molar concentration of at least 0.2) and/or relatively small quantities of nitrates (e.g. at an anionic molar concentration of at least 0.01 and at most 0.1). Preferably, the molten salt mixture is non-oxidizing or non-explosive when brought into contact with crude oil.

### CROSS-REFERENCE TO RELATED APPLICATIONS

The present application claims priority to U.S. Provisional Application No. 61/714,251 filed on Oct. 16, 2012, which is incorporated by reference herein in its entirety.

### FIELD OF THE INVENTION

Embodiments of the invention relate to methods and apparatus for pyrolyzing kerogen or for mobilizing bitumen by thermal energy of heated molten salt.

### BACKGROUND

Hydrocarbons obtained from subterranean formations are often used as energy resources, as feedstocks, and as consumer products. Concerns over depletion of available hydrocarbon resources and concerns over declining overall quality of produced hydrocarbons have led to development of processes for more efficient recovery, processing and/or use of available hydrocarbon resources. In situ processes may be used to remove hydrocarbon materials from subterranean formations that were previously inaccessible and/or too expensive to extract using available methods. Chemical and/or physical properties of hydrocarbon material in a subterranean formation may need to be changed to allow hydrocarbon material to be more easily removed from the subterranean formation and/or increase the value of the hydrocarbon material. The chemical and physical changes may include in situ reactions that produce removable fluids, composition changes, solubility changes, density changes, phase changes, and/or viscosity changes of the hydrocarbon material in the formation.

Large deposits of heavy hydrocarbons (heavy oil and/or tar) contained in relatively permeable formations (for example in tar sands) are found in North America, South America, Africa, and Asia. Tar can be surface-mined and upgraded to lighter hydrocarbons such as crude oil, naphtha, kerosene, and/or gas oil. Surface milling processes may further separate the bitumen from sand. The separated bitumen may be converted to light hydrocarbons using conventional refinery methods. Mining and upgrading tar sand is usually substantially more expensive than producing lighter hydrocarbons from conventional oil reservoirs.

Retorting processes for oil shale may be generally divided into two major types: aboveground (surface) and underground (in situ). Aboveground retorting of oil shale typically involves mining and construction of metal vessels capable of withstanding high temperatures. The quality of oil produced from such retorting may typically be poor, thereby requiring costly upgrading. Aboveground retorting may also adversely affect environmental and water resources due to mining, transporting, processing, and/or disposing of the retorted material. Many U.S. patents have been issued relating to aboveground retorting of oil shale. Currently available aboveground retorting processes include, for example, direct, indirect, and/or combination heating methods.

In situ retorting typically involves retorting oil shale without removing the oil shale from the ground by mining modified in situ processes typically require some mining to develop underground retort chambers. An example of a “modified” in situ process includes a method developed by Occidental Petroleum that involves mining approximately 20% of the oil shale in a formation, explosively rubblizing the remainder of the oil shale to fill up the mined out area, and combusting the oil shale by gravity stable combustion in which combustion is initiated from the top of the retort. Other examples of “modified” in situ processes include the “Rubble In Situ Extraction” (“RISE”) method developed by the Lawrence Livermore Laboratory (“LLL”) and radio-frequency methods developed by IIT Research Institute (“IITRI”) and LLL, which involve tunneling and mining drifts to install an array of radio-frequency antennas in an oil shale formation.

Obtaining permeability in an oil shale formation between injection and production wells tends to be difficult because oil shale is often substantially impermeable. Drilling such wells may be expensive and time consuming. Many methods have attempted to link injection and production wells.

Many different types of wells or wellbores may be used to treat the hydrocarbon containing formation using an in situ heat treatment process. In some embodiments, vertical and/or substantially vertical wells are used to treat the formation. In some embodiments, horizontal or substantially horizontal wells (such as J-shaped wells and/or L-shaped wells), and/or U-shaped wells are used to treat the formation. In some embodiments, combinations of horizontal wells, vertical wells, and/or other combinations are used to treat the formation. In certain embodiments, wells extend through the overburden of the formation to a hydrocarbon containing layer of the formation. In some situations, heat in the wells is lost to the overburden. In some situations, surface and overburden infrastructures used to support heaters and/or production equipment in horizontal wellbores or U-shaped wellbores are large in size and/or numerous.

Wellbores for heater, injection, and/or production wells may be drilled by rotating a drill bit against the formation. The drill bit may be suspended in a borehole by a drill string that extends to the surface. In some cases, the drill bit may be rotated by rotating the drill string at the surface. Sensors may be attached to drilling systems to assist in determining direction, operating parameters, and/or operating conditions during drilling of a wellbore. Using the sensors may decrease the amount of time taken to determine positioning of the drilling systems. For example, U.S. Pat. No. 7,093,370 to Hansberry and U.S. Patent Application Publication No. 2009-027041 to Zaeper et al., both of which are incorporated herein by reference, describe a borehole navigation systems and/or sensors to drill wellbores in hydrocarbon formations. At present, however, there are still many hydrocarbon containing formations where drilling wellbores is difficult, expensive, and/or time consuming.

Heaters may be placed in wellbores to heat a formation during an in situ process. There are many different types of heaters which may be used to heat the formation. Examples of in situ processes utilizing downhole heaters are illustrated in U.S. Pat. No. 2,634,961 to Ljungstrom; U.S. Pat. No. 2,732,195 to Ljungstrom; U.S. Pat. No. 2,780,450 to Ljungstrom; U.S. Pat. No. 2,789,805 to Ljungstrom; U.S. Pat. No. 2,923,535 to Ljungstrom; U.S. Pat. No. 4,886,118 to Van Meurs et al.; and U.S. Pat. No. 6,688,387 to Wellington et al.; each of which is incorporated by reference as if fully set forth herein.

U.S. Pat. No. 7,575,052 to Sandberg et al. and U.S. Patent Application Publication No. 2008-0135254 to Vinegar et al., each of which are incorporated herein by reference, describe an in situ heat treatment process that utilizes a circulation system to heat one or more treatment areas. The circulation system may use a heated liquid heat transfer fluid that passes through piping in the formation to transfer heat to the formation.

US Patent Application Publication No. 2009-0095476 to Nguyen et al., which is incorporated herein by reference, describes a heating system for a subsurface formation that includes a conduit located in an opening in the subsurface formation. An insulated conductor is located in the conduit. A material is in the conduit between a portion of the insulated conductor and a portion of the conduit. The material may be a salt. The material is a fluid at the operating temperature of the heating system. Heat transfers from the insulated conductor to the fluid, from the fluid to the conduit, and from the conduit to the subsurface formation.

In situ production of hydrocarbons from tar sand may be accomplished by heating and/or injecting fluids into the formation. U.S. Pat. No. 4,084,637 to Todd; U.S. Pat. No. 4,926,941 to Glandt et al.; U.S. Pat. No. 5,046,559 to Glandt, and U.S. Pat. No. 5,060,726 to Glandt, each of which are incorporated herein by reference, describe methods of producing viscous materials from subterranean formations that includes passing electrical current through the subterranean formation. Steam may be injected from the injector well into the formation to produce hydrocarbons.

U.S. Pat. No. 4,930,574 to Jager, which is incorporated herein by reference, describes a method for tertiary oil recovery and gas utilization by the introduction of nuclear-heated steam into an oil field and the removal, separation and preparation of an escaping oil-gas-water mixture.

US Patent Application Publication 20100270015 to Vinegar et al. discloses that an oil shale formation may be treated using an in situ thermal process. A mixture of hydrocarbons, H₂, and/or other formation fluids may be produced from the formation. Heat may be applied to the formation to raise a temperature of a portion of the formation to a pyrolysis temperature. Heat sources may be used to heat the formation. The heat sources may be positioned within the formation in a selected pattern.

US Patent Application Publication No. 20090200031 to Miller et al., which is incorporated herein by reference, discloses a method for treating a hydrocarbon containing formation includes providing heat input to a first section of the formation from one or more heat sources located in the first section. Fluids are produced from the first section through a production well located at or near the center of the first section. The heat sources are configured such that the average heat input per volume of formation in the first section increases with distance from the production well.

As discussed above, there has been a significant amount of effort to develop methods and systems to economically produce hydrocarbons, hydrogen, and/or other products from hydrocarbon containing formations. At present, however, there are still many hydrocarbon containing formations from which hydrocarbons, hydrogen, and/or other products cannot be economically produced. Thus, there is a need for improved methods and systems for heating of a hydrocarbon formation and production of fluids from the hydrocarbon formation. There is also a need for improved methods and systems that reduce energy costs for treating the formation, reduce emissions from the treatment process, facilitate heating system installation, and/or reduce heat loss to the overburden as compared to hydrocarbon recovery processes that utilize surface based equipment.

### SUMMARY OF EMBODIMENTS

Embodiments of the present invention relate to a method and system for pyrolyzing kerogen or mobilizing bitumen using thermal energy of a heated carbonate molten salt mixture having a melting point of at most 395 degrees Celsius or at most 390 degrees Celsius or at most 385 degrees Celsius. The carbonate molten salt may include lithium cations (e.g. at a cationic molar concentration of at least 0.2) and/or relatively small quantities of nitrates (e.g. at an anionic molar concentration of at least 0.01 and at most 0.1). Preferably, the molten salt mixture is non-oxidizing or non-explosive when brought into contact with crude oil.

In one embodiment, the molten salt flows through a sub-surface conduit so that thermal energy from the molten salt is transferred to a kerogen-containing or bitumen-containing subsurface formation. In another embodiment, the molten salt flows through a sub-surface conduit in thermal communication with a bed of kerogen-containing or bitumen-containing rocks—for example, pieces of oil shale or pieces of coal or tar sands.

Generally speaking, when hot molten salt flows through a sealed conduit in thermal communication with the kerogen or bitumen, thermal energy is transferred thereto from the hot molten salt. Because there is always a chance that the molten salt can leak through the conduit to contact the kerogen or bitumen, it is preferred to use molten salts that do not combust the kerogen or bitumen when contacted thereto.

Combustion experiments conducted by the present inventors using oil shale from the Ghareb basin indicate that, in contrast to nitrate molten salts which combust the oil shale when brought into contact thereto, carbonate molten salts do not combust the oil shale when similarly brought into contact. Other positive features of molten carbon salts include their relative non-corrosiveness and their relatively high decomposition temperature which may exceed that of nitrate molten salts.

Despite these advantages, many carbonate molten salts freeze at relatively high temperatures—for example, about 400 degrees Celsius. As such, it may be relatively difficult to assure molten salt flow in relatively long sub-surface conduits, jeopardizing the viability of carbonate molten salts as a heat-transfer fluid for pyrolyzing sub-surface kerogen or mobilizing sub-surface bitumen. In contrast, melting points of many nitrate-based solar salts are at least 150 degrees Celsius below that of carbonate solar salts.

It is now disclosed that even a slight melting point reduction may significantly increase the utility of carbonate molten salt for applications related to heating a sub-surface formation and/or to pyrolyzing kerogen or mobilizing bitumen. In particular, melting point experiments conducted by the present inventors indicate that small quantities of nitrates, when mixed with the carbonate molten salt, can reduce the melting point of carbonate molten salts by between about 5 degrees and about 15 degrees Celsius. At low concentrations of nitrate, it is believed that the carbonate molten salt retains its ability to contact oil shale without combusting the oil shale.

It is now disclosed that this relatively small melting point reduction is, in fact, quite significant for applications related to heating kerogen or bitumen (e.g. in situ in the subsurface). In one embodiment, synthetic oil having a maximum working between about 380 degrees Celsius and 400 degrees Celsius first flows through the sub-surface conduit to pre-heat the conduit. Subsequently, the carbonate molten salt at higher temperatures flows (and having a higher maximum working temperature) through the sub-surface conduit

As noted above, the presence of nitrates within the carbonate-molten salt may depress the melting point thereof by at least about 5 degrees Celsius. For example, the nitrates may reduce the melting point from about 397 degrees Celsius to at most 395 degrees or at most 390 degrees or at most 385 degrees Celsius. Despite the fact that this melting point reduction is relatively small in absolute terms, this melting point reduction may significantly increase the working-temperature overlap between carbonate molten salt and synthetic oil, making carbonate molten salt a viable option for heating sub-surface hydrocarbon-containing formations.

It is now disclosed a system for heating a sub-surface hydrocarbon-containing formation comprising: a. a molten salt mixture comprising CO₃²⁻ and Li⁺; b. a furnace configured to heat the molten salt mixture; c. sub-surface conduit(s) disposed within the hydrocarbon-containing formation; d. a molten salt flow system configured to cause the heated molten salt mixture to flow through the sub-surface conduit(s) so as to transfer thermal energy from the furnace to the sub-surface hydrocarbon-containing formation via the molten salt mixture, wherein: i. a CO₃²⁻ anionic molar fraction of the mixture is between 0.7 and 0.999; ii. a melting point of the molten salt mixture is at most 395 degrees Celsius; and iii. a Li⁺ cationic molar fraction of the mixture being at least 0.2.

It is now disclosed a system for heating a sub-surface hydrocarbon-containing formation comprising: a. molten salt mixture comprising (i) CO₃²⁻ and NO₃⁻ and (ii) at least two of Li⁺, Na⁺ and K⁺; b. a furnace configured to heat the molten salt mixture; c. sub-surface conduit(s) disposed within the hydrocarbon-containing formation; and d. a molten salt flow system configured to cause the heated molten salt mixture to flow through the sub-surface conduit(s) so as to transfer thermal energy from the furnace to the sub-surface hydrocarbon-containing formation via the molten salt mixture, wherein: i. an CO₃²⁻ anionic molar fraction is between 0.8 and 0.99; ii. a sum of the NO₃⁻ anionic molar fraction and the CO₃²⁻ anionic molar fraction is at least 0.95; iii. for each cation of at least two members of the cation set {Li⁺, Na⁺ and K⁺}, a respective cationic molar fraction is equal to at least 0.2; and iv. a melting point of the molten salt mixture is at most 395 degrees Celsius.

It is now disclosed a system for heating a sub-surface hydrocarbon-containing formation comprising: a. a molten salt mixture comprising CO₃²⁻ and NO₃⁻ b. a furnace configured to heat the molten salt mixture; c. sub-surface conduit(s) disposed within the hydrocarbon-containing formation; and d. a molten salt flow system configured to cause the heated molten salt mixture to flow through the sub-surface conduit(s) so as to transfer thermal energy from the furnace to the sub-surface hydrocarbon-containing formation via the molten salt mixture, wherein: i. an CO₃²⁻ anionic molar fraction is between 0.8 and 0.99; ii. a sum of the NO₃⁻ anionic molar fraction and the CO₃²⁻ anionic molar fraction is at least 0.95; iii. a melting point of the molten salt mixture is at most 395 degrees Celsius.

It is now disclosed a system for production of hydrocarbon fluids comprising: a. a rock bed of hydrocarbon-containing rocks; b. a molten salt mixture comprising CO₃²⁻ and Li⁺; c. a furnace configured to heat the molten salt mixture; d. conduit(s) in thermal communication with the hydrocarbon-containing rocks of the rock bed; and e. a molten salt flow system configured to cause the heated molten salt mixture to flow through the conduit(s) so as to transfer thermal energy from the furnace to the hydrocarbon-containing rocks of the rock bed via the molten salt mixture, wherein: i. a CO₃²⁻ anionic molar fraction of the mixture is 0.7 and 0.999; ii. a melting point of the molten salt mixture is at most 395 degrees Celsius; and iii. a Li⁺ cationic molar fraction of the mixture being at least 0.2.

It is now disclosed a system for production of hydrocarbon fluids comprising: a. a rock bed of hydrocarbon-containing rocks; b. a molten salt mixture comprising (i) CO₃²⁻ and NO₃⁻ and (ii) at least two of Li⁺, Na⁺ and K⁺; c. a furnace configured to heat the molten salt mixture; d. conduit(s) in thermal communication with the hydrocarbon-containing rocks of the rock bed; and e. a molten salt flow system configured to cause the heated molten salt mixture to flow through the conduit(s) so as to transfer thermal energy from the furnace to the hydrocarbon-containing rocks of the rock bed via the molten salt mixture, wherein: i. an CO₃²⁻ anionic molar fraction is between 0.8 and 0.99; ii. a sum of the NO₃⁻ anionic molar fraction and the CO₃²⁻ anionic molar fraction is at least 0.95; iii. for each cation of at least two members of the cation set {Li⁺, Na⁺ and K⁺}, a respective cationic molar fraction is equal to at least 0.2; and iv. a melting point of the molten salt mixture is at most 395 degrees Celsius.

It is now disclosed a system for production of hydrocarbon fluids comprising: a. a rock bed of hydrocarbon-containing rocks; b. a molten salt mixture comprising CO₃²⁻, and NO₃⁻; c. a furnace configured to heat the molten salt mixture; d. conduit(s) in thermal communication with the hydrocarbon-containing rocks of the rock bed; and e. a molten salt flow system configured to cause the heated molten salt mixture to flow through the conduit(s) so as to transfer thermal energy from the furnace to the hydrocarbon-containing rocks of the rock bed via the molten salt mixture, wherein: i. an CO₃²⁻anionic molar fraction is between 0.8 and 0.99; ii. a sum of the NO₃⁻ anionic molar fraction and the CO₃²⁻ anionic molar fraction is at least 0.95; iii. a melting point of the molten salt mixture is at most 395 degrees Celsius.

In some embodiments, the rock bed is disposed within an interior of an excavated enclosure.

In some embodiments, the enclosure is a pit or an impoundment.
In some embodiments, wherein the interior region is maintained under anoxic conditions during the heating.
In some embodiments, the bed of rocks comprises at least one of (i) pieces of oil shale; (ii) pieces of coal; and (iii) tar sands.
In some embodiments, the furnace is selected from the group consisting of (i) an electrical furnace; (ii) a solar furnace; (iii) a nuclear furnace; and (iv) a fuel burning furnace.
It is now disclosed a molten salt mixture comprising CO₃²⁻ and Li⁺, wherein a CO₃²⁻ anionic molar fraction of the mixture is between 0.7 and 0.999, a melting point of the mixture is at most 395 degrees Celsius, and a Li⁺ cationic molar fraction of the mixture is at least 0.2.
It is now disclosed a molten salt mixture wherein:
i. an CO₂⁻ anionic molar fraction is between 0.8 and 0.99;
ii. a sum of the NO₃⁻ anionic molar fraction and the CO₃²⁻ anionic molar fraction is at least 0.95;
iii. at least two of Li⁺, Na⁺ and K⁺, a respective cationic molar fractions exceeds 0.2; and
iv. a melting point of the molten salt mixture is at most 395 degrees Celsius.
   In some embodiments, a melting point of the molten salt mixture is at most 394 degrees Celsius.
   In some embodiments, a melting point of the molten salt mixture is at most 392 degrees Celsius.
   In some embodiments, a melting point of the molten salt mixture is at most 390 degrees Celsius.
   In some embodiments, melting point of the molten salt mixture is at most 388 degrees Celsius or at most 386 degrees Celsius or at most 385 degrees Celsius or at most 384 degrees Celsius or at most 382 degrees Celsius or at most 380 degrees Celsius.
   In some embodiments, the molten salt mixture is non-explosive when brought into contact with crude oil.
   In some embodiments, the molten salt mixture is non-explosive when brought into contact with bituminous coal or anthracite coal.
   In some embodiments, a cationic molar fractions of K⁺ exceeds that of Na⁺.
   In some embodiments, a melting point of the molten salt mixture is at least 375 degrees Celsius or at least 380 degrees Celsius.
   In some embodiments, the molten salt mixture has a decomposition temperature of at least 600 degrees Celsius or at least 650 degrees Celsius or at least 550 degrees Celsius. In some embodiments, the NO₃⁻ anionic molar fraction of the molar salt mixture is at least 0.01, or at least 0.03, or at least 0.04, or at least 0.05, or at least 0.06, or at least 0.07, or at least 0.08, or at least 0.09 and/or at most 0.1 or at most 0.09 or at most 0.08 or at most 0.07 or at most 0.06 or at most 0.05 or at most 0.04.
   In some embodiments, a cationic molar fraction of K⁺ in the molten salt mixture of exceeds that Na⁺.
   In some embodiments, for at least two members (or at least three members) of the cation set {Li₊, Na₊ and K₊}, a respective cationic molar fraction of the molten salt mixture is equal to at least 0.2 or at least 0.25 or at least 0.275 or at least 0.3.
   In some embodiments, a cationic molar fraction of Li⁺ in the molten salt mixture is at least 0.1 or at least 0.15 or at least 0.2 or at least 0.25.
   In some embodiments, for each member of the cation set {Li₊, Na₊ and K₊}, a respective cationic molar fraction of the molten salt mixture is equal to at least 0.2 or at least 0.25 or at least 0.275 or at least 0.3.
   In some embodiments, the mixture comprises at least 0.1 or at least 0.15 or at least 0.2 or at least 0.25 molar fraction Li₊.
   In some embodiments, a CO₃²⁻ anionic mole fraction of the molten salt mixture is at most 0.99 or at most 0.98 or at most 0.97 or at most 0.96 or at most 0.95 and/or at least 0.75 or at least 0.8 or at least 0.85 or at least 0.9 or at least 0.95.
   In some embodiments, (i) a melting point of the molten salt mixture is at least 375 degrees Celsius; and/or (ii) a decomposition temperature of the mixture at least 550 degrees Celsius or at least 600 degrees Celsius or at least 650 degrees Celsius.
   In some embodiments, the NO₃⁻ anionic mole fraction of the molten salt mixture is at least 0.01, or at least 0.03, or at least 0.04, or at least 0.05, or at least 0.06, or at least 0.07, or at least 0.08, or at least 0.09 and/or at most 0.1 or at most 0.09 or at most 0.08 or at most 0.07 or at most 0.06 or at most 0.05 or at most 0.04.
   In some embodiments, a sum of the Li₊ mole fraction, the Na₊ mole fraction and the K+ mole fraction is at least 0.8 or at least 0.85 or at least 0.95.
   In some embodiments, a sum of the Li⁺ molar fraction, the Na⁺ molar fraction and the K⁺ molar fraction of the molten salt mixture is at least 0.8 or at least 0.85 or at least 0.95.
   In some embodiments, comprising at least one of sodium cations, potassium cations, magnesium cations, iron cations, zinc cations and calcium cations.
   It is now disclosed a method of heating a subsurface hydrocarbon-containing formation comprising: a. deploying a sacrificial conduit within a subsurface wellbore within the hydrocarbon-containing formation; b. during a first stage of heating, causing a first hot heat transfer fluid to flow within a subsurface sacrificial conduit so that the sacrificial conduit substantially seals the heat transfer fluid therewithin while thermal energy is transferred therefrom to the formation; c. during a second stage of heating, causing a second hot heat transfer fluid to flow within the subsurface conduit so as to corrode the sacrificial conduit; during a third stage of heating, causing the second hot heat transfer fluid to flow within the wellbore in the substantial absence of the sacrificial conduit.
   In some embodiments, the first hot heat transfer fluid is an oil for example a synthetic oil.
   In some embodiments, the second hot heat transfer fluid is a molten salt.
   In some embodiments, the second hot heat transfer fluid is the molten salt mixture of any preceding claim.
   It is now disclosed a method of heating a subsurface hydrocarbon-containing formation comprising: causing a liquid-phase molten salt mixture comprising primarily carbonate molten salts to flow within a wellbore of a subsurface formation while the liquid-phase molten salt is in contact with the formation.
   In some embodiments, the flowing molten salt is the molten salt mixture of any of any preceding claim.
   In some embodiments, carried out to pyrolyze kerogen or to mobilize bitumen.
   In some embodiments, the molten salt mixture comprises at least 1%, by mass, nitrate molten salt.
   In some embodiments, the molten salt mixture is non-explosive when brought into contact with crude oil.
   In some embodiments, a melting point of molten salt mixture is at most 392 degrees Celsius, or at most 390 degrees Celsius or at most 388 degrees Celsius or at most 386 degrees Celsius or at most 385 degrees Celsius.
   In some embodiments, during a later phase of the heating, the liquid molten salt flows within a conduit formed by a frozen derivative thereof.

### DETAILED DESCRIPTION OF EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the exemplary system only and are presented in the cause of providing what is believed to be a useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice and how to make and use the embodiments.

For brevity, some explicit combinations of various features are not explicitly illustrated in the figures and/or described. It is now disclosed that any combination of the method or device features disclosed herein can be combined in any manner—including any combination of features—and any combination of features can be included in any embodiment and/or omitted from any embodiments.

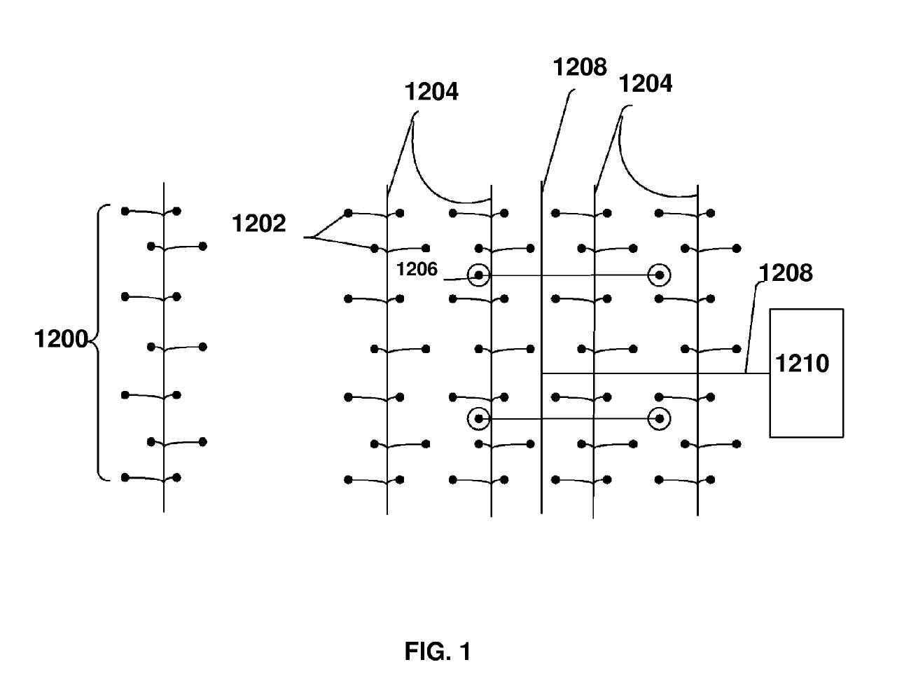

FIG. 1 depicts a schematic view of an embodiment of a portion of the in situ heat treatment system for treating the hydrocarbon containing formation. The in situ heat treatment system may include barrier wells 1200. Barrier wells are used to form a barrier around a treatment area. The barrier inhibits fluid flow into and/or out of the treatment area. Barrier wells include, but are not limited to, dewatering wells, vacuum wells, capture wells, injection wells, grout wells, freeze wells, or combinations thereof. In some embodiments, barrier wells 1200 are dewatering wells. Dewatering wells may remove liquid water and/or inhibit liquid water from entering a portion of the formation to be heated, or to the formation being heated. In the embodiment depicted in FIG. 1, the barrier wells 1200 are shown extending only along one side of heater sources 1202, but the barrier wells typically encircle all heat sources 1202 used, or to be used, to heat a treatment area of the formation.

Heat sources 1202 are placed in at least a portion of the formation. Heat sources 1202 may include heaters such as insulated conductors, conductor-in-conduit heaters, surface burners, flameless distributed combustors, and/or natural distributed combustors. Heat sources 1202 may also include other types of heaters. Heat sources 1202 provide heat to at least a portion of the formation to heat hydrocarbons in the formation. Energy may be supplied to heat sources 1202 through supply lines 1204. Supply lines 1204 may be structurally different depending on the type of heat source or heat sources used to heat the formation. Supply lines 1204 for heat sources may transmit electricity for electric heaters, may transport fuel for combustors, or may transport heat exchange fluid that is circulated in the formation. In some embodiments, electricity for an in situ heat treatment process may be provided by a nuclear power plant or nuclear power plants. The use of nuclear power may allow for reduction or elimination of carbon dioxide emissions from the in situ heat treatment process.

When the formation is heated, the heat input into the formation may cause expansion of the formation and geomechanical motion. The heat sources may be turned on before, at the same time, or during a dewatering process. Computer simulations may model formation response to heating. The computer simulations may be used to develop a pattern and time sequence for activating heat sources in the formation so that geomechanical motion of the formation does not adversely affect the functionality of heat sources, production wells, and other equipment in the formation.

Heating the formation may cause an increase in permeability and/or porosity of the formation. Increases in permeability and/or porosity may result from a reduction of mass in the formation due to vaporization and removal of water, removal of hydrocarbons, and/or creation of fractures. Fluid may flow more easily in the heated portion of the formation because of the increased permeability and/or porosity of the formation. Fluid in the heated portion of the formation may move a considerable distance through the formation because of the increased permeability and/or porosity. The considerable distance may be over 1000 m depending on various factors, such as permeability of the formation, properties of the fluid, temperature of the formation, and pressure gradient allowing movement of the fluid. The ability of fluid to travel considerable distance in the formation allows production wells 1206 to be spaced relatively far apart in the formation.

Production wells 1206 are used to remove formation fluid from the formation. In some embodiments, production well 1206 includes a heat source. The heat source in the production well may heat one or more portions of the formation at or near the production well. In some in situ heat treatment process embodiments, the amount of heat supplied to the formation from the production well per meter of the production well is less than the amount of heat applied to the formation from a heat source that heats the formation per meter of the heat source. Heat applied to the formation from the production well may increase formation permeability adjacent to the production well by vaporizing and removing liquid phase fluid adjacent to the production well and/or by increasing the permeability of the formation adjacent to the production well by formation of macro and/or micro fractures.

More than one heat source may be positioned in the production well. A heat source in a lower portion of the production well may be turned off when superposition of heat from adjacent heat sources heats the formation sufficiently to counteract benefits provided by heating the formation with the production well. In some embodiments, the heat source in an upper portion of the production well may remain on after the heat source in the lower portion of the production well is deactivated. The heat source in the upper portion of the well may inhibit condensation and reflux of formation fluid.

In some embodiments, the heat source in production well 1206 allows for vapor phase removal of formation fluids from the formation. Providing heating at or through the production well may: (1) inhibit condensation and/or refluxing of production fluid when such production fluid is moving in the production well proximate the overburden, (2) increase heat input into the formation, (3) increase production rate from the production well as compared to a production well without a heat source, (4) inhibit condensation of high carbon number compounds (C₆ hydrocarbons and above) in the production well, and/or (5) increase formation permeability at or proximate the production well.

Subsurface pressure in the formation may correspond to the fluid pressure generated in the formation. As temperatures in the heated portion of the formation increase, the pressure in the heated portion may increase as a result of thermal expansion of in situ fluids, increased fluid generation and vaporization of water. Controlling rate of fluid removal from the formation may allow for control of pressure in the formation. Pressure in the formation may be determined at a number of different locations, such as near or at production wells, near or at heat sources, or at monitor wells.

In some hydrocarbon containing formations, production of hydrocarbons from the formation is inhibited until at least some hydrocarbons in the formation have been mobilized and/or pyrolyzed. Formation fluid may be produced from the formation when the formation fluid is of a selected quality. In some embodiments, the selected quality includes an API gravity of at least about 20⁰, 30⁰, or 40⁰. Inhibiting production until at least some hydrocarbons are mobilized and/or pyrolyzed may increase conversion of heavy hydrocarbons to light hydrocarbons. Inhibiting initial production may minimize the production of heavy hydrocarbons from the formation. Production of substantial amounts of heavy hydrocarbons may require expensive equipment and/or reduce the life of production equipment.

In some hydrocarbon containing formations, hydrocarbons in the formation may be heated to mobilization and/or pyrolysis temperatures before substantial permeability has been generated in the heated portion of the formation. An initial lack of permeability may inhibit the transport of generated fluids to production wells 1206. During initial heating, fluid pressure in the formation may increase proximate heat sources 1202. The increased fluid pressure may be released, monitored, altered, and/or controlled through one or more heat sources 1202. For example, selected heat sources 1202 or separate pressure relief wells may include pressure relief valves that allow for removal of some fluid from the formation.

In some embodiments, pressure generated by expansion of mobilized fluids, pyrolysis fluids or other fluids generated in the formation may be allowed to increase although an open path to production wells 1206 or any other pressure sink may not yet exist in the formation. The fluid pressure may be allowed to increase towards a lithostatic pressure. Fractures in the hydrocarbon containing formation may form when the fluid approaches the lithostatic pressure. For example, fractures may form from heat sources 1202 to production wells 1206 in the heated portion of the formation. The generation of fractures in the heated portion may relieve some of the pressure in the portion. Pressure in the formation may have to be maintained below a selected pressure to inhibit unwanted production, fracturing of the overburden or underburden, and/or coking of hydrocarbons in the formation.

After mobilization and/or pyrolysis temperatures are reached and production from the formation is allowed, pressure in the formation may be varied to alter and/or control a composition of formation fluid produced, to control a percentage of condensable fluid as compared to non-condensable fluid in the formation fluid, and/or to control an API gravity of formation fluid being produced. For example, decreasing pressure may result in production of a larger condensable fluid component. The condensable fluid component may contain a larger percentage of olefins.

In some in situ heat treatment process embodiments, pressure in the formation may be maintained high enough to promote production of formation fluid with an API gravity of greater than 20⁰. Maintaining increased pressure in the formation may inhibit formation subsidence during in situ heat treatment. Maintaining increased pressure may reduce or eliminate the need to compress formation fluids at the surface to transport the fluids in collection conduits to treatment facilities.

Maintaining increased pressure in a heated portion of the formation may surprisingly allow for production of large quantities of hydrocarbons of increased quality and of relatively low molecular weight. Pressure may be maintained so that formation fluid produced has a minimal amount of compounds above a selected carbon number. The selected carbon number may be at most 25, at most 20, at most 12, or at most 8. Some high carbon number compounds may be entrained in vapor in the formation and may be removed from the formation with the vapor. Maintaining increased pressure in the formation may inhibit entrainment of high carbon number compounds and/or multi-ring hydrocarbon compounds in the vapor. High carbon number compounds and/or multi-ring hydrocarbon compounds may remain in a liquid phase in the formation for significant time periods. The significant time periods may provide sufficient time for the compounds to pyrolyze to form lower carbon number compounds.

Generation of relatively low molecular weight hydrocarbons is believed to be due, in part, to autogenous generation and reaction of hydrogen in a portion of the hydrocarbon containing formation. For example, maintaining an increased pressure may force hydrogen generated during pyrolysis into the liquid phase within the formation. Heating the portion to a temperature in a pyrolysis temperature range may pyrolyze hydrocarbons in the formation to generate liquid phase pyrolyzation fluids. The generated liquid phase pyrolyzation fluids components may include double bonds and/or radicals. Hydrogen (H₂) in the liquid phase may reduce double bonds of the generated pyrolyzation fluids, thereby reducing a potential for polymerization or formation of long chain compounds from the generated pyrolyzation fluids. In addition, H₂ may also neutralize radicals in the generated pyrolyzation fluids. H₂ in the liquid phase may inhibit the generated pyrolyzation fluids from reacting with each other and/or with other compounds in the formation.

Formation fluid produced from production wells 1206 may be transported through collection piping 1208 to treatment facilities 1210. Formation fluids may also be produced from heat sources 1202. For example, fluid may be produced from heat sources 1202 to control pressure in the formation adjacent to the heat sources. Fluid produced from heat sources 1202 may be transported through tubing or piping to collection piping 1208 or the produced fluid may be transported through tubing or piping directly to treatment facilities 1210. Treatment facilities 1210 may include separation units, reaction units, upgrading units, fuel cells, turbines, storage vessels, and/or other systems and units for processing produced formation fluids. The treatment facilities may form transportation fuel from at least a portion of the hydrocarbons produced from the formation. In some embodiments, the transportation fuel may be jet fuel, such as JP-8.

Formation fluid may be hot when produced from the formation through the production wells. Hot formation fluid may be produced during solution mining processes and/or during in situ heat treatment processes. In some embodiments, electricity may be generated using the heat of the fluid produced from the formation. Also, heat recovered from the formation after the in situ process may be used to generate electricity. The generated electricity may be used to supply power to the in situ heat treatment process. For example, the electricity may be used to power heaters, or to power a refrigeration system for forming or maintaining a low temperature barrier. Electricity may be generated using a Kalina cycle, Rankine cycle or other thermodynamic cycle. In some embodiments, the working fluid for the cycle used to generate electricity is aqua ammonia.

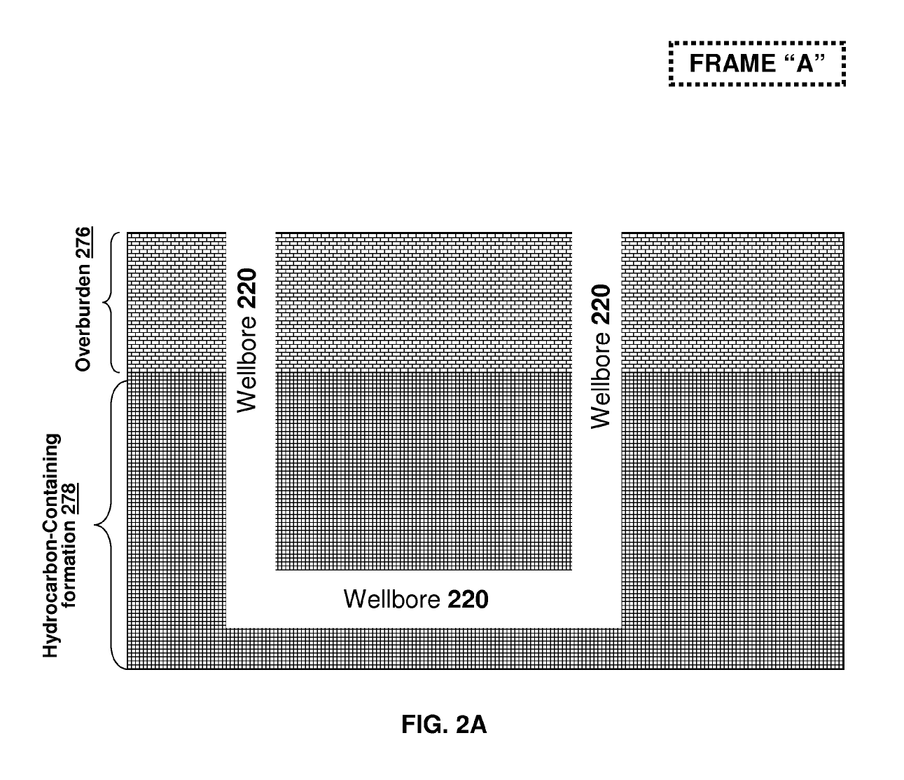

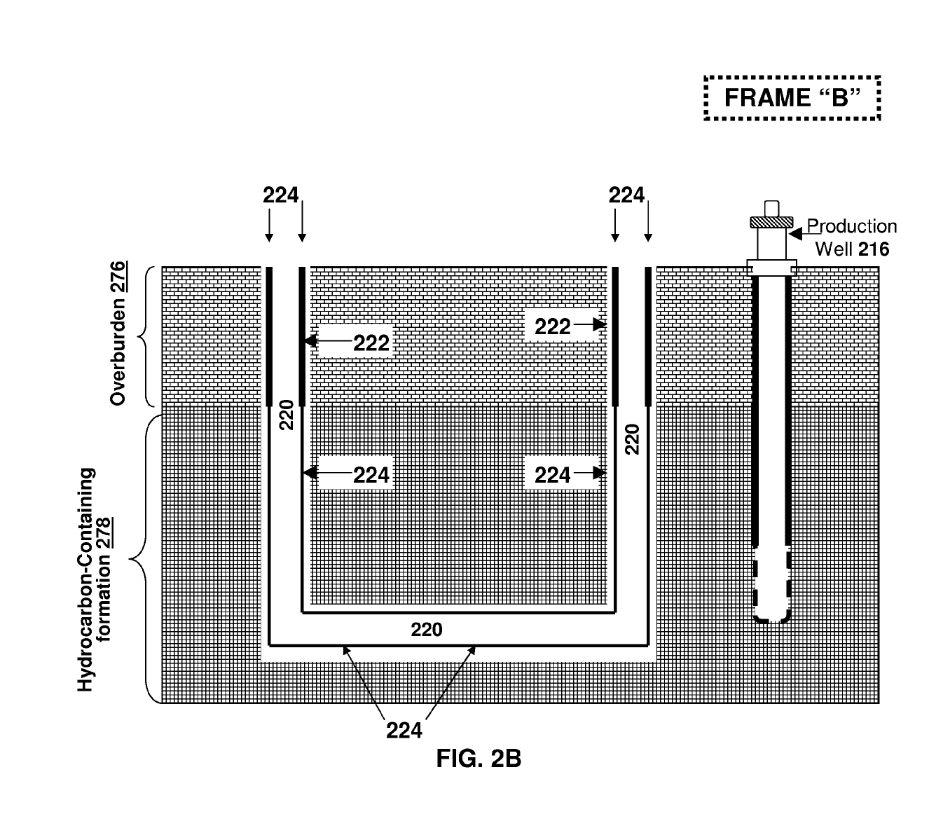

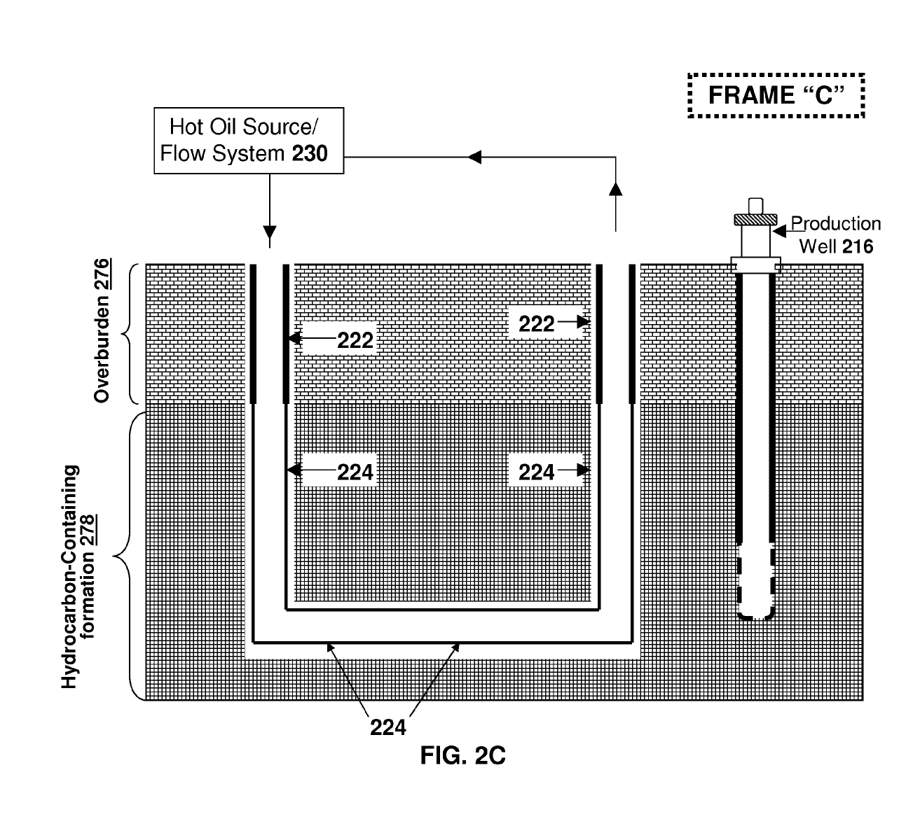

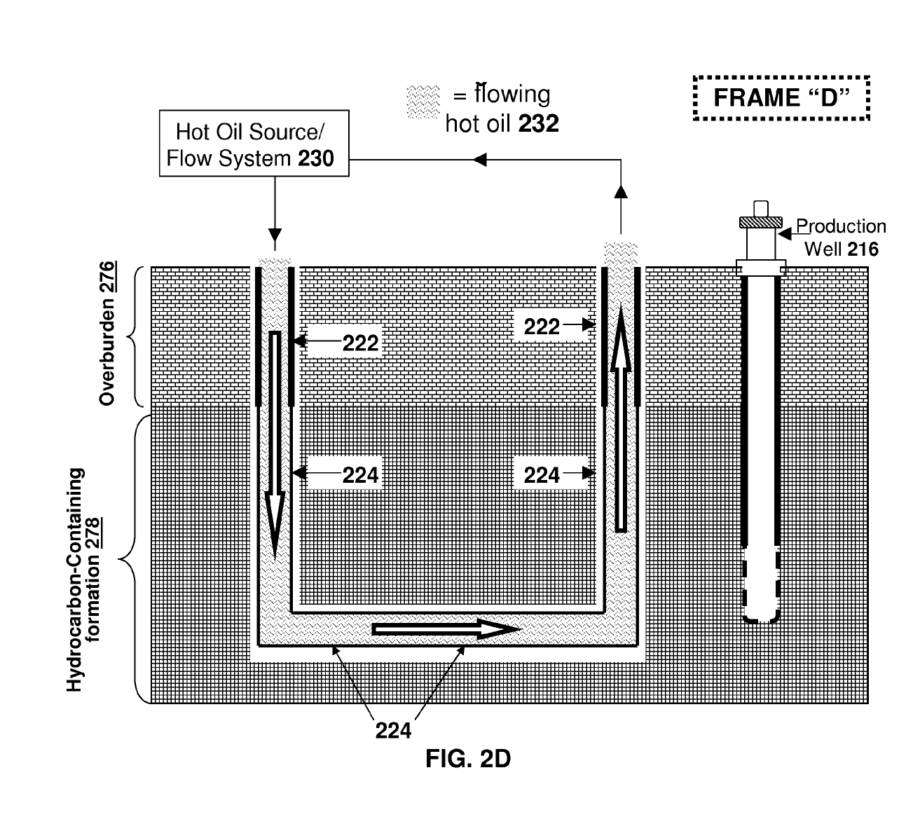

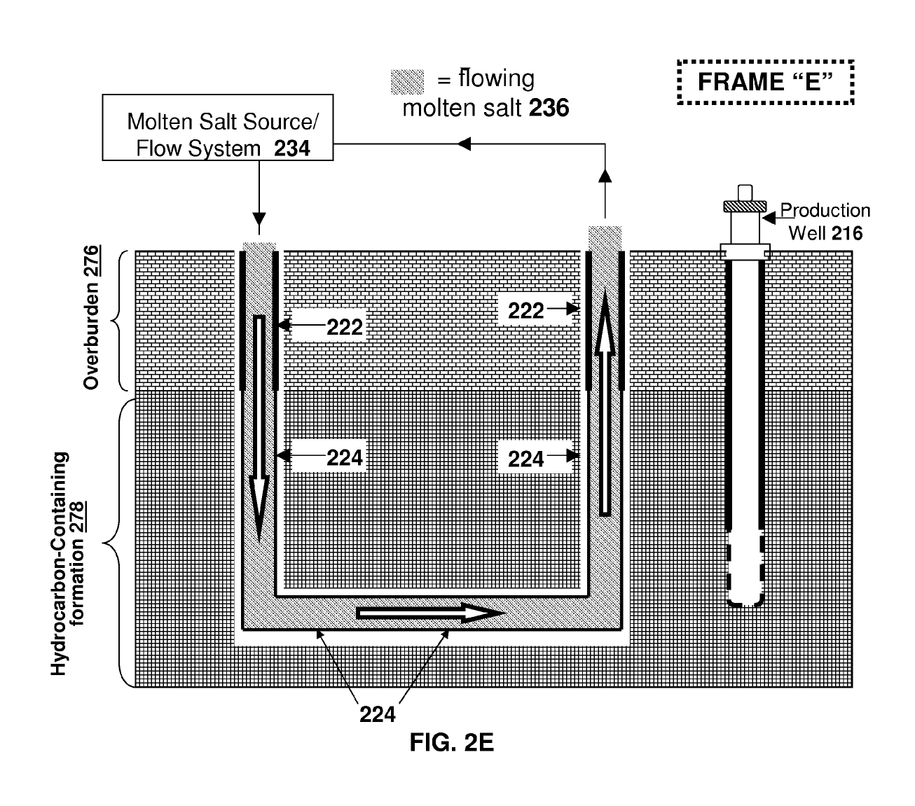

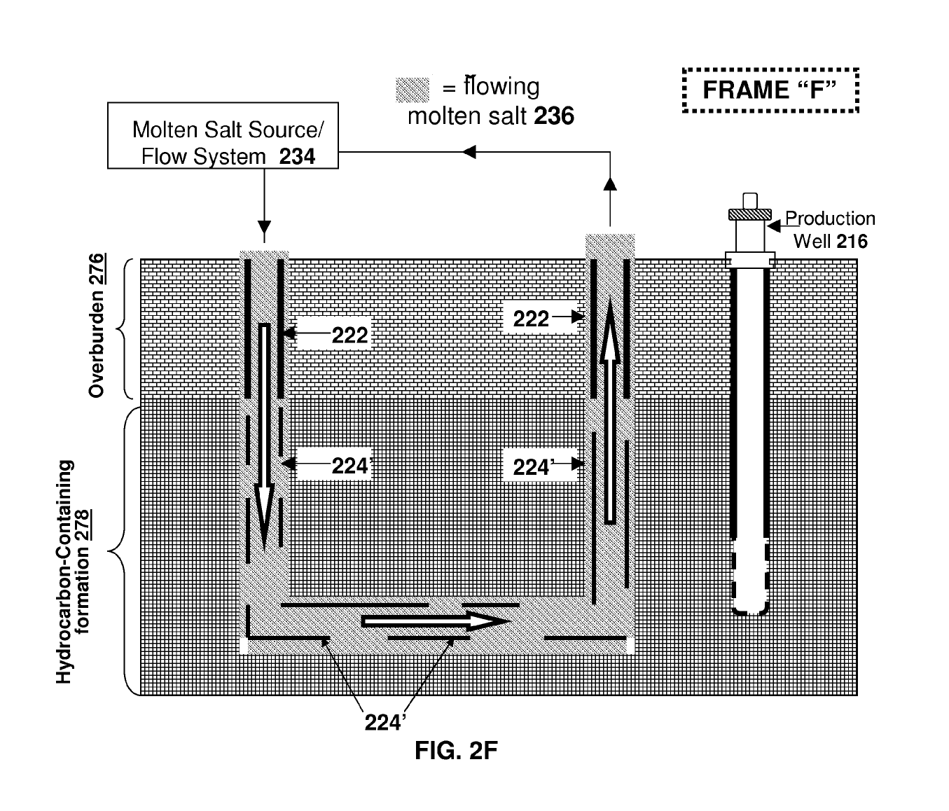

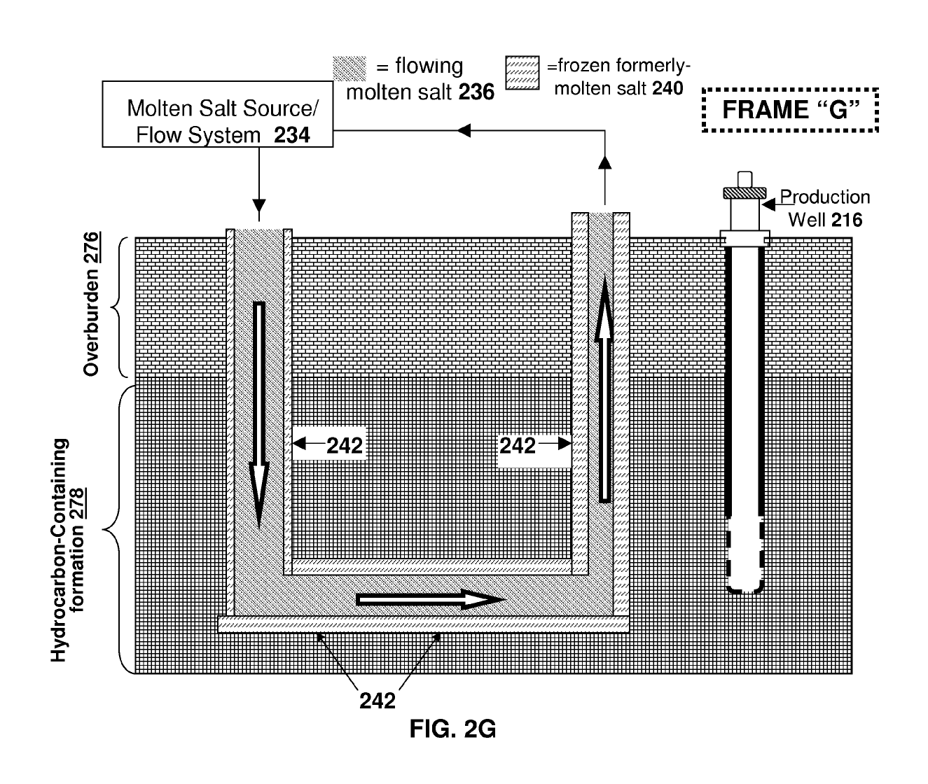

FIG. 2A-2G illustrates a method for in situ thermal treatment of a subsurface formation. In some embodiments, the subsurface formation is a hydrocarbon-containing formation such as a kerogen-containing formation (e.g. an oil shale or coal formation) or a bitumen formation or a heavy oil formation.

In “Frame A” a wellbore (e.g. U-shaped) is drilled through the overburden 276 into the subsurface formation 278. In “Frame B” a conduit assembly is install within wellbore 220—the lower portion 224 of the conduit assembly is a so-called ‘sacrificial conduit’ which will lose its ability to seal at a later stage (Frame “F” discussed below) of the method. An upper portion 222 of the conduit assembly will be more corrosion resistant to molten salt—e.g. made of a higher quality and/or thicker material. The lower portion 224 may be thin carbon steel.

In Frames C-D hot synthetic oil 232 (e.g. having a temperature between 380 and 400 degrees Celsius) is circulated through the conduit assembly within the subsurface 278. Both upper 222 and lower 224 portions of the conduit assembly function to substantially seal the synthetic oil from the subsurface formation 278. This serves to pre-heat the subsurface formation.

In Frame E, instead of circulating synthetic hot-oil to pre-heat the subsurface formation, it is possible to circulate a hot molten salt (e.g. a mixture comprising carbonate salts, e.g. primarily carbonate salts) 236 through the conduit assembly. A maximum operating temperature of the molten salt may significantly exceed (e.g. by 100 degrees Celsius or more) that of the synthetic oil.

One salient feature of the conduit assembly is that the lower portion 224 is not significantly resistant to corrosion caused by the flow of the molten salt. While initially the lower portion 224 may seal the flowing molten salt therewithin (see Frame “E”) after time (e.g. even a short period of time) holes may form (see Frame “F”) in the lower portion 224′ of the conduit assembly so that molten salt leaks out (see Frame “F”). At that point, molten salt flows directly within the wellbore and is not constrained to flow within the conduit embedded in the wellbore.

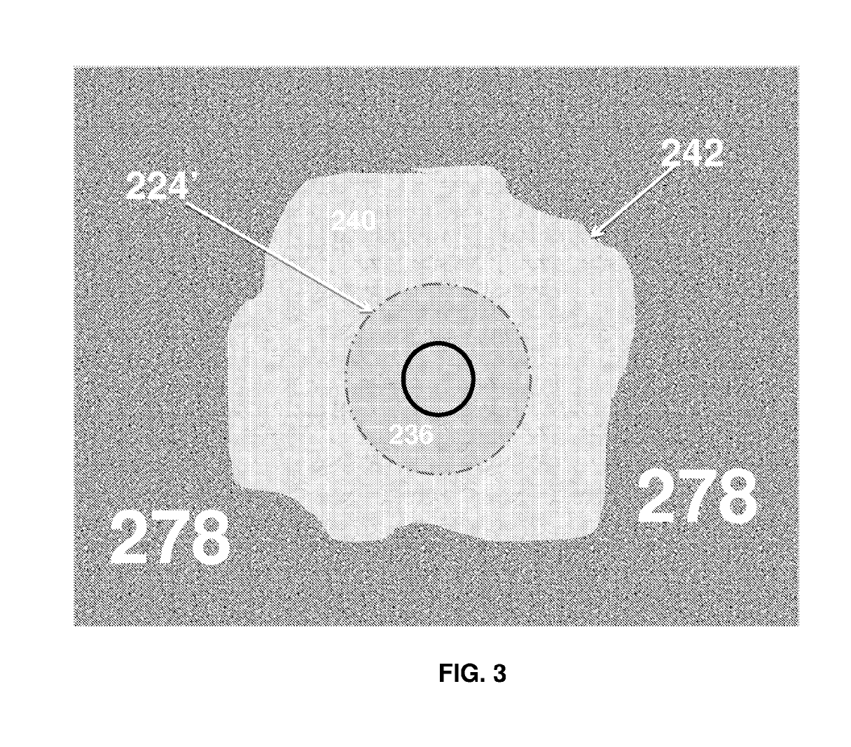

At outer locations a flow of the molten salt might not be as strong—at these locations, the molten salt may freeze. In “Frame G” the molten salt flows within a freeze front 242 which functions as a conduit to define a flow path generally following that of the well-bore. This is also illustrated in FIG. 3 which is a cross section of the wellbore 220 within the hydrocarbon-containing formation 278. This cross section illustrates the flowing molten salt 236, the remnants 224′ of the sacrificial conduit, and the freeze front 242.

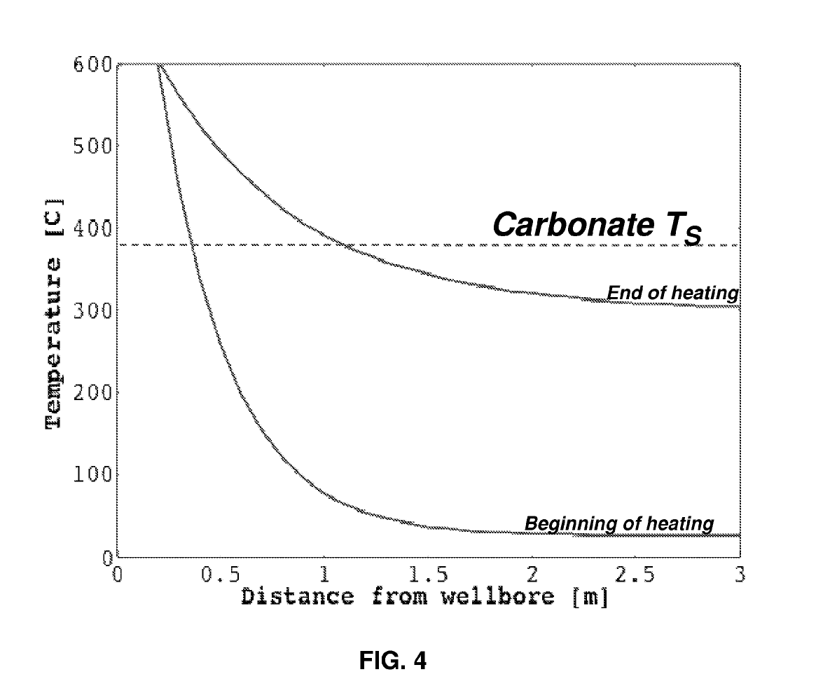

After ‘Frame “D” and before Frame “E,” a temperature within the wellbore 220 is substantially that of the hot synthetic oil. The molten salt is introduced in Frame “E” from the molten salt source/flow system 234 may be significantly hotter than the synthetic oil. Over time, the hotter molten salt (i.e. hotter than the synthetic oil) will further heat the formation 278. This is illustrated in FIG. 4 where at the ‘end of heating’ the temperature at various distances from the wellbore is significantly greater than what would be observed at the ‘beginning of heating’—in particular, in most or all locations above 300 degrees Celsius, sufficient to pyrolyze the formation.

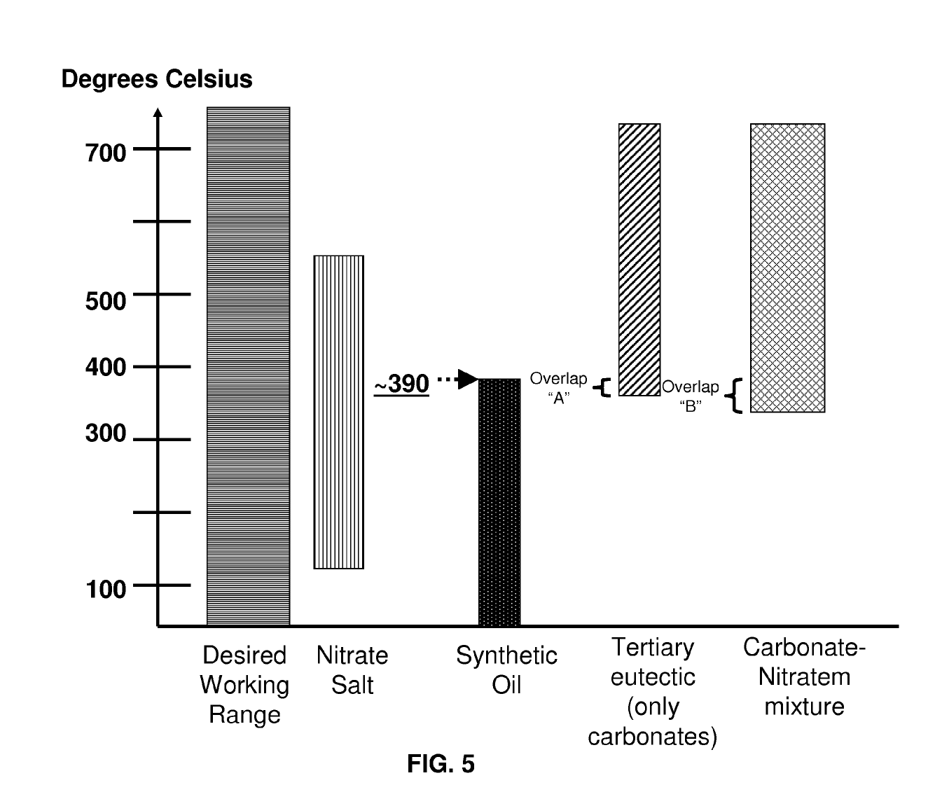

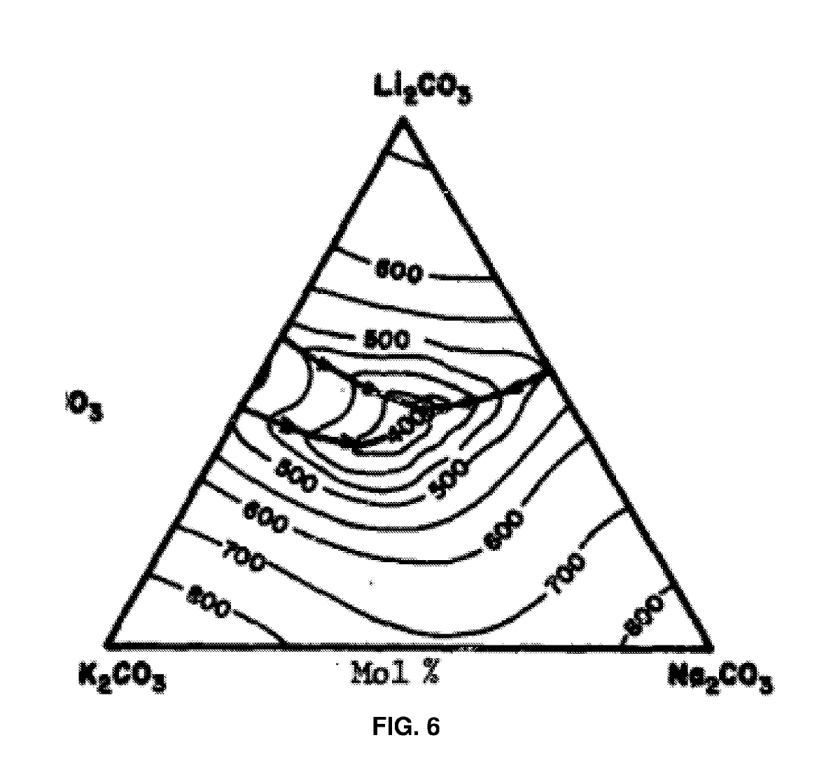

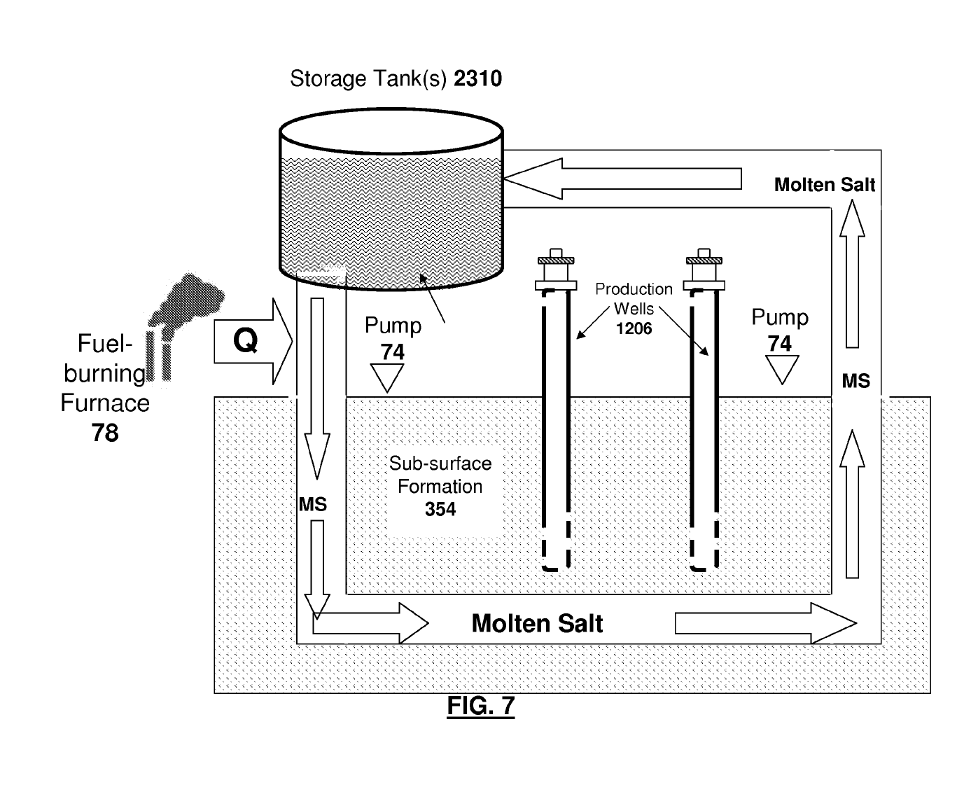

As illustrated in FIG. 5, in an ideal circumstance, a heat transfer fluid has a very large working range—e.g. from about 25 degrees Celsius to above degrees 700 Celsius. Employing an extremely hot heat transfer fluid at these temperatures allows for a much more rapid heating of the subsurface and faster pyrolysis. Unfortunately, no single fluid illustrated in FIG. 5 has these properties. Nitrate salt may decompose above 500 degrees Celsius or above 550 degrees Celsius, synthetic oil may only be heated to up to about 390 or about 400 degrees Celsius, and carbonate molten salts may have a relatively high freeze temperatures (even eutectics). As illustrated in FIG. 7 a decomposition temperature of carbonate molten salt may significantly exceed that of nitrate molten salts.

Although in theory it is possible to pre-heat the wellbore 220 to a temperature that is above of a melting point of carbonate molten salt, the maximum operating temperature of the synthetic oil may only exceed the melting point of the carbonate molten salt by a few degrees Celsius (see Overlap “A” of FIG. 5) which increases the chance of the molten salt freezing when first introduced into wellbore 220 (e.g. because a temperature of wellbore 220 may be a few degrees below a maximum operating temperature of the synthetic oil).

The present inventor is now disclosing molten salt mixtures including carbonates where small concentrations of nitrate salts are added to depress the freeze point (e.g. to obtain ‘overlap “B”). In particular, by depressing the freeze point of a primarily carbonate molten salt mixture, it is possible to enjoy the benefit of the relatively high decomposition temperature of carbonate molten salts while improving the flow assurance when first introducing the molten salt in the wellbore 220—i.e. due to the larger overlap ‘B.’

Because nitrate may be combustable in combination with bitumen or kerogen, nitrate salts are only present in relatively low concentrations—for example, the NO₃⁻ anionic molar fraction may be at most 0.25 or at most 0.2 or at most 0.15 or at most 0.1 or at most 0.05. Although the freeze points of the presently-disclosed mixtures may only be 1-20 degrees Celsius less than the carbonate eutectic freeze point, restricting the nitrate concentration to relatively low levels allows the mixture to be used in situ without combusting the hydorcarbon resource (e.g. kerogen or bitumen). The present inventors are disclosing that the relatively small drop in melting point is sufficient for providing flow assurance when switching over to carbonate-based molten salt from synthetic oil.

### Examples

The above description is not intended to limit the claimed invention in any manner; furthermore, the discussed combination of features might not be absolutely necessary for the inventive solution.

The present invention will be further illustrated in the following examples. However it is to be understood that these examples are for illustrative purposes only, and should not be used to limit the scope of the present invention in any manner.

### Example

### Melt/Freeze Point Variations Due to Potassium Nitrate

An experiment was carried out to determine how the melting and freezing temperature of a specific carbonate mixture changed as varying levels of KNO₃ were added to the composition. In this experiment, a weight percentage of 32.1% Li₂CO₃, 33.4% Na₂CO₃, and 34.5% K₂CO₃ was maintained for the initial control mixture, containing no KNO₃. Subsequent mixtures, containing KNO₃, also upheld this ratio of different carbonates. In addition to the control mixture, mixtures containing weight percentages of 5%, 10% and 15% KNO₃ had their melting and freezing temperatures measured. To weigh each mixture, an Ohaus CD-11 digital scale was used. Upon weighing each mixture, salts were stirred and transferred into grade 316 steel canisters. Heat was supplied through a 240 VAC HTS/Amptek heating tape located on the bottom half of the 316 SS canister. In addition to the tape, these steel canisters had three k-type thermocouples welded to their exteriors. Two were designated to measure the exterior temperature of the canister at different locations, and one was used to provide feedback, to control the temperature of the heating tape through a PID algorithm in LabVIEW. An internal thermocouple was placed through a hole in the top of the canister, to measure the temperature of the mixture. Two canisters were insulated with a single ½ inch layer of Kaowool RT and three ½ inch layers of Pyrogel XT-5. Another canister was layered and sealed with a single layer of kaowool and submerged in microtherm powder. Canister contents, for both types of insulation, were heated to 500° C., to melt the contents, and then the solutions were mixed, to homogenize the contents. Labview was used to record to the values of temperature at all attached thermocouples.

The measured melting points are reported in the table below:

| KNO₃ Weight Percentage | Freeze/Melt Point |
|---|---|
| 0% | 397° C. |
| 5% | 389° C. |
| 10% | 388° C. |
| 15% | 387° C. |

In some embodiments, is KNO₃ preferred over to NaNO₃ depress the freezing point.

### Discussion of FIG. 7

FIG. 7 relates to an in-situ system for thermal treatment of a hydrocarbon-containing formation. A quantity of molten salt (e.g. any molten salt mixture described herein) is disposed within storage tank 2310.

A furnace 78 is configured to heat the molten salt mixture—in the non-limiting example of FIG. 7, furnace 78 burns a fuel such as coal or natural gas. Other examples of furnaces are electric furnaces, solar furnaces and nuclear furnaces.

a molten salt flow system (e.g. including pumps 74) are configured to cause the heated molten salt mixture to flow through the sub-surface conduit(s) so as to transfer thermal energy from the furnace to the sub-surface hydrocarbon-containing formation via the molten salt mixture—i.e. first the furnace heats the molten salt mixture and then thermal energy from the furnace-heating is transferred to the formation 354.

Also illustrated in FIG. 7 are production wells—for example, thermal energy from the molten salt is used to pyrolyze kerogen or mobilize bitumen so that formation fluids (e.g. including hydrocarbon formation fluids) are recovered via production wells 1206.

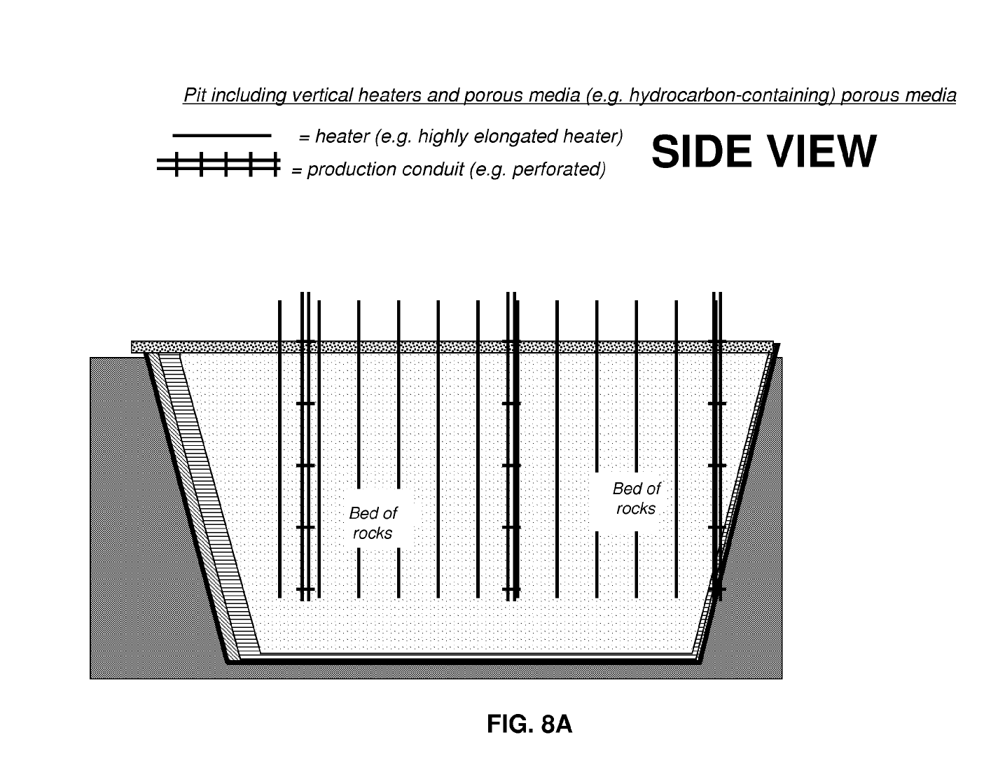

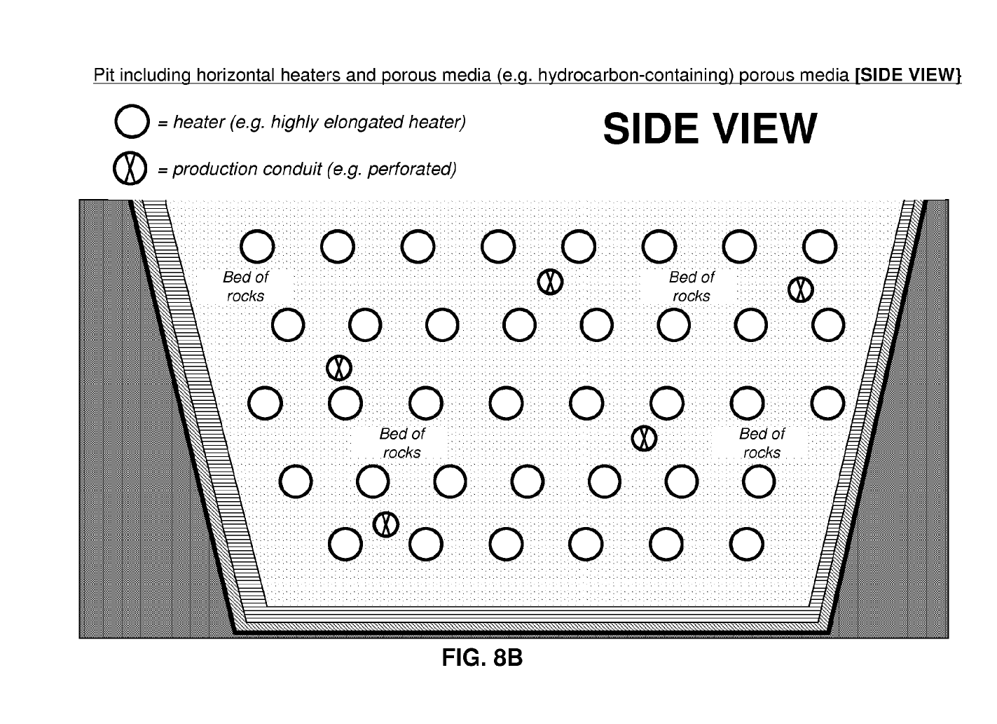

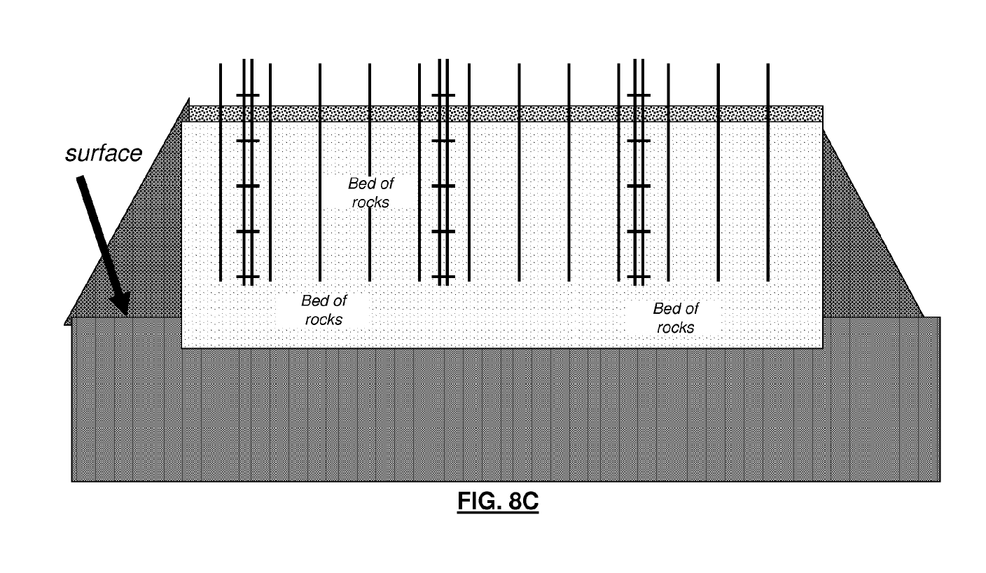

### Discussion of FIGS. 8A-8C

FIGS. 8A-8C illustrate systems for pyrolyzing kerogen or mobilizing bitumen wherein a bed of rocks (e.g. pieces of coal or oil shale, or tar sands) is disposed within an excavated enclosure (e.g. within an anoxic environment).

Embodiments of the present invention relate to apparatus and methods for heating hydrocarbon-containing matter (e.g. tar sands or kerogen-containing rocks such as pieces of coal or pieces of oil shale) within an enclosure such as a pit or an impoundment or a container. Hydrocarbon-containing rocks are introduced into the enclosure to form a bed (e.g. a packed-bed) of rock therein. Oxygen may be evacuated (e.g. under vacuum or by means of an inert sweep gas) to create a substantially oxygen-free environment within the enclosure. In different embodiments, the enclosure may be a pit, or an impoundment or a container. The enclosure may be entirely below ground level, partially below and partially above, or entirely above ground level.

Operation of heaters in thermal communication with the hydrocarbon-containing rocks may sufficiently heat the rocks to convert kerogen or bitumen thereof into pyrolysis formation fluids comprising hydrocarbon pyrolysis fluids. The formation fluids may be recovered via production conduits, or via a liquid outlet located at or near the bottom of the enclosure and/or via a vapor outlet located near the top of the enclosure, or in any other manner.

Examples of hydrocarbon-containing rocks are kerogen-containing rocks (e.g. mined oil shale or mined coal) and bitumen-containing rocks (e.g. tar sands).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one. (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art.

What is claimed is:

1. A system for heating a sub-surface hydrocarbon-containing formation comprising:
a. a molten salt mixture comprising CO₃²⁻ and Li⁺;
b. a furnace configured to heat the molten salt mixture;
c. sub-surface conduit(s) disposed within the hydrocarbon-containing formation;
d. a molten salt flow system configured to cause the heated molten salt mixture to flow through the sub-surface conduit(s) so as to transfer thermal energy from the furnace to the sub-surface hydrocarbon-containing formation via the molten salt mixture, wherein:
i. a CO₃²⁻ anionic molar fraction of the mixture is between 0.7 and 0.999;
ii. a melting point of the molten salt mixture is at most 395 degrees Celsius; and
iii. a Li⁺ cationic molar fraction of the mixture being at least 0.2.

2. A system for heating a sub-surface hydrocarbon-containing formation comprising:
a. molten salt mixture comprising (i) CO₃²⁻ and NO₃⁻ and (ii) at least two of Li⁺, Na⁺ and K⁺;
b. a furnace configured to heat the molten salt mixture;
c. sub-surface conduit(s) disposed within the hydrocarbon-containing formation;
d. a molten salt flow system configured to cause the heated molten salt mixture to flow through the sub-surface conduit(s) so as to transfer thermal energy from the furnace to the sub-surface hydrocarbon-containing formation via the molten salt mixture, wherein:
i. an CO₃²⁻ anionic molar fraction is between 0.8 and 0.99;
ii. a sum of the NO₃⁻ anionic molar fraction and the CO₃²⁻ anionic molar fraction is at least 0.95;
iii. for each cation of at least two members of the cation set {Li⁺, Na⁺ and K⁺}, a respective cationic molar fraction is equal to at least 0.2; and
iv. a melting point of the molten salt mixture is at most 395 degrees Celsius.

3. A system for heating a sub-surface hydrocarbon-containing formation comprising:
a. a molten salt mixture comprising CO₃²⁻ and NO₃⁻
b. a furnace configured to heat the molten salt mixture;
c. sub-surface conduit(s) disposed within the hydrocarbon-containing formation; and
d. a molten salt flow system configured to cause the heated molten salt mixture to flow through the sub-surface conduit(s) so as to transfer thermal energy from the furnace to the sub-surface hydrocarbon-containing formation via the molten salt mixture, wherein:
i. an CO₃²⁻ anionic molar fraction is between 0.8 and 0.99;
ii. a sum of the NO₃⁻ anionic molar fraction and the CO₃²⁻ anionic molar fraction is at least 0.95;
iii. a melting point of the molten salt mixture is at most 395 degrees Celsius.

4. A system for production of hydrocarbon fluids comprising:
a. a rock bed of hydrocarbon-containing rocks;
b. a molten salt mixture comprising CO₃²⁻ and Li⁺;
c. a furnace configured to heat the molten salt mixture;
d. conduit(s) in thermal communication with the hydrocarbon-containing rocks of the rock bed; and
e. a molten salt flow system configured to cause the heated molten salt mixture to flow through the conduit(s) so as to transfer thermal energy from the furnace to the hydrocarbon-containing rocks of the rock bed via the molten salt mixture, wherein:
i. a CO₃²⁻ anionic molar fraction of the mixture is 0.7 and 0.999;
ii. a melting point of the molten salt mixture is at most 395 degrees Celsius; and
iii. a Li⁺ cationic molar fraction of the mixture being at least 0.2.

5. A system for production of hydrocarbon fluids comprising:
a. a rock bed of hydrocarbon-containing rocks;
b. a molten salt mixture comprising (i) CO₃²⁻ and NO₃⁻ and (ii) at least two of Li⁺, Na⁺ and K⁺;
c. a furnace configured to heat the molten salt mixture;
d. conduit(s) in thermal communication with the hydrocarbon-containing rocks of the rock bed; and
e. a molten salt flow system configured to cause the heated molten salt mixture to flow through the conduit(s) so as to transfer thermal energy from the furnace to the hydrocarbon-containing rocks of the rock bed via the molten salt mixture, wherein:
i. an CO₃²⁻ anionic molar fraction is between 0.8 and 0.99;
ii. a sum of the NO₃⁻ anionic molar fraction and the CO₃²⁻ anionic molar fraction is at least 0.95;
iii. for each cation of at least two members of the cation set {Li⁺, Na⁺ and K⁺}, a respective cationic molar fraction is equal to at least 0.2; and
iv. a melting point of the molten salt mixture is at most 395 degrees Celsius.

6. A system for production of hydrocarbon fluids comprising:
a. a rock bed of hydrocarbon-containing rocks;
b. a molten salt mixture comprising CO₃²⁻, and NO₃⁻;
c. a furnace configured to heat the molten salt mixture;
d. conduit(s) in thermal communication with the hydrocarbon-containing rocks of the rock bed; and
e. a molten salt flow system configured to cause the heated molten salt mixture to flow through the conduit(s) so as to transfer thermal energy from the furnace to the hydrocarbon-containing rocks of the rock bed via the molten salt mixture, wherein:
i. an CO₃²⁻ anionic molar fraction is between 0.8 and 0.99;
ii. a sum of the NO₃⁻ anionic molar fraction and the CO₃²⁻ anionic molar fraction is at least 0.95;
iii. a melting point of the molten salt mixture is at most 395 degrees Celsius.

7. The system of any of claims 4-6 wherein the rock bed is disposed within an interior of an excavated enclosure.

8. The system of claim 7 wherein the enclosure is a pit or an impoundment.

9. The system of any of claims 7-8 wherein the interior region is maintained under anoxic conditions during the heating.

10. The system of any of claims 4-7 wherein the bed of rocks comprises at least one of (i) pieces of oil shale; (ii) pieces of coal; and (iii) tar sands.

11. The system of any preceding claims wherein the furnace is selected from the group consisting of (i) an electrical furnace; (ii) a solar furnace; (iii) a nuclear furnace; and (iv) a fuel burning furnace.

12. A molten salt mixture comprising CO₃²⁻ and Li⁺, wherein a CO₃²⁻ anionic molar fraction of the mixture is between 0.7 and 0.999, a melting point of the mixture is at most 395 degrees Celsius, and a Li⁺ cationic molar fraction of the mixture is at least 0.2.

13. A molten salt mixture comprising (i) CO₃²⁻ and NO₃⁻ and (ii) at least two of Li⁺, Na⁺ and K⁺ wherein:
i. an CO₃²⁻ anionic molar fraction is between 0.8 and 0.99;
ii. a sum of the NO₃⁻ anionic molar fraction and the CO₃²⁻ anionic molar fraction is at least 0.95;
iii. at least two of Li⁺, Na⁺ and K⁺, a respective cationic molar fractions exceeds 0.2; and
iv. a melting point of the molten salt mixture is at most 395 degrees Celsius.

14. The system or mixture of any preceding claim wherein a melting point of the molten salt mixture is at most 394 degrees Celsius.

15. The system or mixture of any preceding claim wherein a melting point of the molten salt mixture is at most 392 degrees Celsius.

16. The system or mixture of any preceding claim wherein a melting point of the molten salt mixture is at most 390 degrees Celsius.

17. The system or mixture of any preceding claim wherein a melting point of the molten salt mixture is at most 388 degrees Celsius.

18. The system or mixture of any preceding claim wherein a melting point of the molten salt mixture is at most 386 degrees Celsius.

19. The system or mixture of any preceding claim wherein a melting point of the molten salt mixture is at most 385 degrees Celsius.

20. The system or mixture of any preceding claim wherein a melting point of the molten salt mixture is at most 384 degrees Celsius.

21. The system or mixture of any preceding claim wherein a melting point of the molten salt mixture is at most 382 degrees Celsius.

22. The system or mixture of any preceding claim wherein a melting point of the molten salt mixture is at most 380 degrees Celsius.

23. The system or mixture of any preceding claim wherein the molten salt mixture is non-explosive when brought into contact with crude oil.

24. The system or mixture of any preceding claim wherein the molten salt mixture is non-explosive when brought into contact with bituminous coal or anthracite coal.

25. The system or mixture of any preceding claim wherein a cationic molar fractions of K⁺ exceeds that of Na⁺.

26. The system or mixture of any preceding claim wherein a melting point of the molten salt mixture is at least 375 degrees Celsius or at least 380 degrees Celsius.

27. The system or mixture of any preceding claim wherein the molten salt mixture has a decomposition temperature of at least 600 degrees Celsius or at least 650 degrees Celsius or at least 550 degrees Celsius.

28. The system or mixture of any preceding claim wherein the NO₃⁻ anionic molar fraction of the molar salt mixture is at least 0.01, or at least 0.03, or at least 0.04, or at least 0.05, or at least 0.06, or at least 0.07, or at least 0.08, or at least 0.09 and/or at most 0.1 or at most 0.09 or at most 0.08 or at most 0.07 or at most 0.06 or at most 0.05 or at most 0.04.

29. The system or mixture of any preceding claim wherein a cationic molar fraction of K⁺ in the molten salt mixture of exceeds that Na⁺.

30. The system or mixture of any preceding claim for at least two members of the cation set {Li₊, Na₊ and K₊}, a respective cationic molar fraction of the molten salt mixture is equal to at least 0.2 or at least 0.25 or at least 0.275 or at least 0.3.

31. The system or mixture of any preceding claim wherein the mixture a cationic molar fraction of Li⁺ in the molten salt mixture is at least 0.1 or at least 0.15 or at least 0.2 or at least 0.25.

32. The system or mixture of any preceding claim for each member of the cation set {Li₊, Na₊ and K₊}, a respective cationic molar fraction of the molten salt mixture is equal to at least 0.2 or at least 0.25 or at least 0.275 or at least 0.3.

33. The system or mixture of any preceding claim wherein the mixture comprises at least 0.1 or at least 0.15 or at least 0.2 or at least 0.25 molar fraction Li₊.

34. The system or mixture of any preceding claim wherein a CO₃²⁻ anionic mole fraction of the molten salt mixture is at most 0.99 or at most 0.98 or at most 0.97 or at most 0.96 or at most 0.95 and/or at least 0.75 or at least 0.8 or at least 0.85 or at least 0.9 or at least 0.95.

35. The molten salt mixture of any preceding claim wherein (i) a melting point of the molten salt mixture is at least 375 degrees Celsius; and/or (ii) a decomposition temperature of the mixture at least 550 degrees Celsius or at least 600 degrees Celsius or at least 650 degrees Celsius.

36. The molten salt mixture of any preceding claim wherein the NO₃⁻ anionic mole fraction of the molten salt mixture is at least 0.01, or at least 0.03, or at least 0.04, or at least 0.05, or at least 0.06, or at least 0.07, or at least 0.08, or at least 0.09 and/or at most 0.1 or at most 0.09 or at most 0.08 or at most 0.07 or at most 0.06 or at most 0.05 or at most 0.04.

37. The mixture of any preceding claim wherein a sum of the Li₊ mole fraction, the Na₊ mole fraction and the K₊ mole fraction is at least 0.8 or at least 0.85 or at least 0.95.

38. The system or mixture of any preceding claim wherein a sum of the Li⁺ molar fraction, the Na⁺ molar fraction and the K⁺ molar fraction of the molten salt mixture is at least 0.8 or at least 0.85 or at least 0.95.

39. The system or mixture of any preceding claim comprising at least one of sodium cations, potassium cations, magnesium cations, iron cations, zinc cations and calcium cations.

50. Use of the system or mixture of any preceding claim to heat in situ a portion of a subsurface hydrocarbon-bearing formation.

41. Use of the system or mixture of any preceding claim to heat in situ a portion of a subsurface hydrocarbon-bearing formation selected from the group consisting of an oil shale formation, a coal formation, a heavy oil formation and a bitumen formation.

42. Use of the system or mixture of any preceding claim to mobilize bitumen and/or pyrolyze bitumen or kerogen.

43. A method of heating a subsurface hydrocarbon-containing formation comprising:
a. deploying a sacrificial conduit within a subsurface wellbore within the hydrocarbon-containing formation;
b. during a first stage of heating, causing a first hot heat transfer fluid to flow within a subsurface sacrificial conduit so that the sacrificial conduit substantially seals the heat transfer fluid therewithin while thermal energy is transferred therefrom to the formation;
c. during a second stage of heating, causing a second hot heat transfer fluid to flow within the subsurface conduit so as to corrode the sacrificial conduit;
during a third stage of heating, causing the second hot heat transfer fluid to flow within the wellbore in the substantial absence of the sacrificial conduit.

44. The method of claim 43 wherein the first hot heat transfer fluid is an oil for example a synthetic oil.

45. The method of any of claims 43-44 wherein the second hot heat transfer fluid is a molten salt.

46. The method of any of claims 43-45 wherein the second hot heat transfer fluid is the molten salt mixture of any preceding claim.

47. A method of heating a subsurface hydrocarbon-containing formation comprising:
causing a liquid-phase molten salt mixture comprising primarily carbonate molten salts to flow within a wellbore of a subsurface formation while the liquid-phase molten salt is in contact with the formation.

48. The method of claim 47 wherein the flowing molten salt is the molten salt mixture of any of any preceding claim.

49. The method any preceding claim, carried out to pyrolyze kerogen or to mobilize bitumen.

50. The system, mixture or method any preceding claim, wherein the molten salt mixture comprises at least 1%, by mass, nitrate molten salt.

51. The system, mixture or method any preceding claim, wherein the molten salt mixture is non-explosive when brought into contact with crude oil.

52. The system, mixture or method any preceding claim, a melting point of molten salt mixture is at most 392 degrees Celsius, or at most 390 degrees Celsius or at most 388 degrees Celsius or at most 386 degrees Celsius or at most 385 degrees Celsius.

53. The system, mixture or method any preceding claim wherein, during a later phase of the heating, the liquid molten salt flows within a conduit formed by a frozen derivative thereof.
